(19) United States
(12) Patent Application Publication
(10) Pub. No.: US 2009/0254686 A1
(43) Pub. Date: Oct. 8, 2009

(54) MEMORY SHARING THROUGH A PLURALITY OF ROUTES

(75) Inventor: Jong-Sik Jeong, Seoul (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 11/917,933

(22) PCT Filed: Jun. 13, 2006
(86) PCT No.: PCT/KR06/02255

§ 371 Date: Dec. 18, 2007

(30) Foreign Application Priority Data
Jun. 28, 2005 (KR) 10-2005-0056177

(51) Int. Cl. G06F 13/36

(52) U.S. Cl. 710/107; 710/308

(57) ABSTRACT

A method for sharing a memory through a plurality of routes and a device thereof are disclosed. The digital processing apparatus in accordance with an embodiment of the present invention comprises a main processor, an application processor controlled by the main processor and coupled to the main processor through one connection bus and a memory having a plurality of ports, each of which is coupled to the application processor through an independent memory bus. With the present invention, the process time for processing a high-performance, high-resolution image can be minimized, and the loss in process efficiency of the application processor can be minimized.

### TECHNICAL FIELD

The present invention is directed to sharing of a memory (storage device), more specifically to a method and a device for having a memory shared by a plurality of processors in an electrical/electronic device (digital processing apparatus).

### BACKGROUND ART

As an example of electrical/electronic devices, portable terminals refer to electronic devices that can be easily carried by making the size compact in order to perform functions such as game and mobile communication. Portable terminals include mobile communication terminals, personal digital assistants (PDA) and portable multimedia players (PMP).

The mobile communication terminal is essentially a device designed to enable a mobile user to telecommunicate with a receiver who is remotely located. Thanks to scientific development, however, the latest mobile communication terminals have functions, such as camera and multimedia data playback, in addition to the basic functions, such as voice communication, short message service and address book.

FIG. 1 shows a block diagram of a conventional mobile communication terminal having a camera function.

Referring to FIG. 1, the mobile communication terminal 100 having a camera function comprises a high frequency processing unit 110, an analog-to-digital converter 115, a digital-to-analog converter 120, a processing unit 125, a power supply 130, a key input 135, a main memory 140, a display 145, a camera 150, an image processing unit 155 and a support memory 160.

The high frequency processing unit 110 processes a high frequency signal, which is transmitted or received through an antenna.

The analog-to-digital converter 115 converts an analog signal, outputted from the high frequency processing unit 110, to a digital signal and sends to the processing unit 125.

The digital-to-analog converter 120 converts a digital signal, outputted from the processing unit 125, to an analog signal and sends to the high frequency processing unit 110.

The processing unit 125 controls the general operation of the mobile communication terminal 100. The processing unit 125 can comprise a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends to the processing unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100, relevant information (e.g. date and time) and an external image photographed by the camera 150.

The camera 150 photographs an external image (a photographic subject), and the image processing unit 155 processes the external image photographed by the camera 150. The image processing unit 155 can perform functions such as color interpolation, gamma correction, image quality correction and JPEG encoding. The support memory 160 stores the external image processed by the image processing unit 155. The support memory 160 can be an SRAM (Static RAM) or an SDRAM (Synchronous DRAM).

As described above, the mobile communication terminal 100 having a camera function is equipped with a plurality of processors (that is, a main processor and one or more application processors for performing additional functions). In other words, as shown in FIG. 1, the processing unit 125 for controlling general functions of the mobile communication terminal 100 and the image processing unit 155 for controlling the camera function are included. The operation of the application processor can be controlled by the main processor. Moreover, each processor is structured to be coupled with an independent memory.

The application processor can take different forms and quantity depending on the kinds of additional functions, with which the portable terminal is equipped. For example, the application processor for controlling the camera function can process functions such as JPEG encoding and JPEG decoding; the application processor for controlling the movie file playback function can process functions such as video file (e.g., MPEG4, DIVX, H.264) encoding and decoding; and the application processor for controlling the music file playback function can process functions such as audio file encoding and decoding. The portable terminal can also comprise an application processor for controlling games. Each of these processing units has an individual memory for storing the processed data.

In an arrangement as this, various attempts are being made to have the memory in each application processor shared by another application processor or the main processor, in order to expand the storage space or improve the process efficiency.

However, the conventional memory sharing structure uses a memory having a single port, delaying the time and lacking the efficiency in processing a high-resolution, high-performance image.

FIG. 2 is a coupling structure between a processor and a memory in accordance with the prior art.

As shown in FIG. 2, one processor can comprise an image signal processor 210, a multimedia processor 220 and a control function processor 230. Each of the processors 210, 220 and 230 is coupled parallel to a memory 240 through one bus.

Each processor accesses the memory sequentially in accordance with the priority or a predetermined order. This is because a plurality of processors can not access the memory 240 at the same time.

This causes each processor to prolong its processing time and makes the processor overwork due to the amount of data. Besides, the length of time for the image signal processor 210 occupying the memory 240 becomes inevitably longer in proportion to the number of pixels of an image sensor, limiting the time used by other processors for predetermined operations.

FIG. 3 is a block diagram showing a main processor and an application processor sharing a supplementary memory coupled to the application processor, in accordance with the prior art. In this description, it is assumed that the application processor is a multimedia processor for controlling an image sensor 330 and for processing multimedia data inputted from the image sensor 330.

Referring to FIG. 3, the main processor 310 comprises a plurality of memory controllers (i.e. a first memory controller 333 and a second memory controller 336). By accessing the multimedia processor 320 through the first memory controller 333, the main processor 310 writes data in the supplementary memory 325 coupled to the multimedia processor 320 or reads data stored in the supplementary memory 325. In addition, the main processor 310 accesses a main memory 315 directly coupled to the main processor 310 through the second memory controller 336 to write data or read the stored data.

The multimedia processor 320 comprises an interface 343, a controller 346, an image scaler 349, a priority control unit 353 and a memory control unit 356. The multimedia processor 320 is coupled to the supplementary memory 325 having one port through one bus (i.e. a second memory bus). In addition, the multimedia processor 320 can be coupled to the display 145 in order to display the processed multimedia data.

The interface 343 communicates information between the multimedia processor 320 and the main processor 310. The multimedia processor 320 carries out an operation corresponding to a control signal received from the main processor 310 through the interface 343.

The controller 346 controls the operation of the multimedia processor 320 in accordance with a control signal received from the main processor 310. The controller 346 can be, for example, an MCU (microcontroller unit).

The image scaler 349 processes data inputted from the image sensor 330 to change the size or color of the image. The data processed by the image scaler 349 is stored in the supplementary memory 325 through the second memory bus by the memory control unit 356.

The priority control unit 353 determines the priority between a request to access the supplementary memory 325 from the multimedia processor 320 and a request to access the supplementary memory 325 from the main processor 310, and controls one of the processors to access the supplementary memory 325. The multimedia processor 320 can access the supplementary memory 325 when storing image data processed by the image scaler 349, processing data stored in the supplementary memory 325 and storing the processed data.

The memory control unit 356 controls one of the processors to access the supplementary memory 325 in accordance with the priority control signal from the priority control unit 353 when the main processor 316 and the multimedia processor 320 request an access to the supplementary memory 325 at the same time.

As shown in FIG. 3, in the conventional memory sharing structure, a plurality of processors and/or elements access a single memory through a single bus. Thus, the main processor 310 has temporal limitation to use a memory of the supplementary processor 320.

For example, in case of playing back an MPEG file, the main processor 310 must deliver the MPEG file, stored in the coupled main memory 315 or inputted real time, to the multimedia processor. Since the size of an MPEG file is large, the MPEG file is first written in the supplementary memory 325 coupled to the multimedia processor 320, and, when necessary, a particular element of the multimedia processor 320 reads the data and decodes the data before delivering the data to the display 145.

As a result, in the memory sharing structure shown in FIG. 3, the bigger the size of the data delivered between the processors is, the more restriction there is in using the supplementary memory 325 connected to the multimedia processor 320. This is because each element included in the multimedia processor 320 must use a bus connected to the supplementary memory 325 every time a process operation is performed.

As described above, the conventional memory sharing structure had the problem of delayed time when processing a high-performance, high-resolution image. Moreover, there has been a loss of process efficiency in the application processor.

### DISCLOSURE

### Technical Problem

Therefore, in order to solve the above problems, it is an object of the present invention to provide a method for sharing a memory through a plurality of routes and a device thereof that can minimize the loss of process efficiency of an application processor and minimize the delay of time when processing a high-performance, high-resolution image.

It is another object of the present invention to provide a method for sharing a memory through a plurality of routes and a device thereof that can allow a main processor to control the application processor and communicate data with the application processor through a single bus.

The present invention also aims to provide a method for sharing a memory through a plurality of routes and a device thereof that can optimize the memory efficiency by allowing image data inputted from an image sensor to be stored in a supplementary memory regardless of the operation status of a multimedia processor.

The present invention also aims to provide a method for sharing a memory through a plurality of routes and a device thereof that can control the loss of data by eliminating the delay in time when storing the image data inputted from the image sensor and maximize the process efficiency of the application processor by applying different ports for storing the image data and for processing the image data.

Other objects of the present invention will become apparent through the preferred embodiments described below.

### Technical Solution

In order to achieve the above objects, an aspect of the present invention features a digital processing apparatus in which a plurality of processors can share a particular memory.

According to a preferred embodiment of the present invention, the digital processing apparatus comprises: a main processor; an application processor, being controlled by the main processor and being connected to the main processor through one connection bus; and a memory, having a plurality of ports, each of which is coupled to the application processor through an independent memory bus.

At least one of the plurality of memory buses is exclusively occupied by the application processor for the purpose of reading data stored in the memory or storing processed data in the memory.

The application processor can comprise an interface, receiving information corresponding to one from a group consisting of a control signal and data from the main processor through the connection bus. The data can be stored in the memory through a memory bus, among the plurality of memory buses, assigned to store data received from the main processor.

The application processor can comprise a processing unit processing input data inputted from a coupled input device. The processed input data can be stored in the memory through a memory bus, among the plurality of memory buses, assigned to store processed input data.

The input device is characterized by being an image sensor.

The application processor can comprise: an interface, receiving information corresponding to one from a group consisting of a control signal and data from the main processor through the connection bus; a processing unit, processing input data inputted from a coupled input device; a priority control unit, generating a priority control signal for data received from the main processor and the processed input data; and a route setting unit, storing the data received from the main processor or the processed input data in the memory through one memory bus, assigned among the plurality of memory buses, to correspond to the priority control signal.

The application processor can have a register for recognizing the purpose of the information; the value registered in the register can be controlled by the main processor; and the interface can determine, upon receiving information from the main processor, whether the information is the control signal or the data, based on the value registered in the register.

The main processor reads registered data by accessing the memory through one assigned memory bus among the plurality of memory buses.

The application processor and the memory are embodied in the same chip.

In order to achieve the above object, another aspect of the present invention features a method for sharing a memory by a plurality of processors and/or a recorded medium recording a program for executing the method thereof.

According to a preferred embodiment of the present invention, the method for sharing a memory coupled to an application processor with a main processor comprises: (a) receiving a request for writing data from the main processor; and (b) writing data in the memory through a first bus, the data corresponding to the received request for writing data. The application processor controlled by the main processor is connected to the main processor through one connection bus; the memory has a plurality of ports; and each port is coupled to the application processor through an independent memory bus.

A second bus, among the plurality of memory buses, is exclusively occupied by the application processor for the purpose of reading data stored in the memory or storing processed data in the memory.

In case input data is further received from an input device, to which the application processor is coupled, the step (b) can comprise: determining the priority of data received from the main processor and the input data, based on a predetermined rule of determining the priority; and in case the data received from the main processor has the priority, writing data corresponding to the request received through the first bus for writing data in the memory through the first bus.

The input device is characterized by being an image sensor.

### DESCRIPTION OF DRAWINGS

FIG. 1 shows a block diagram of a conventional mobile communication terminal having a camera function;

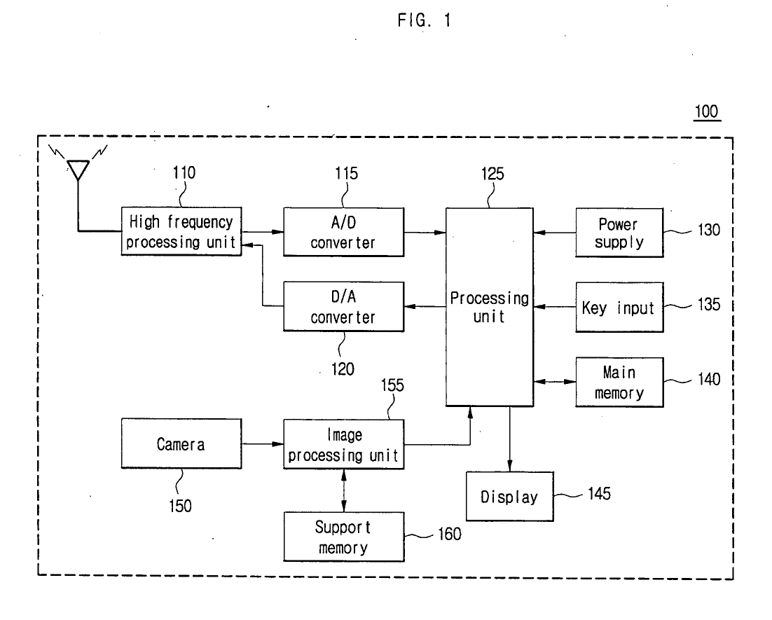

FIG. 2 shows a coupling structure between a processor and a memory in accordance with the prior art;

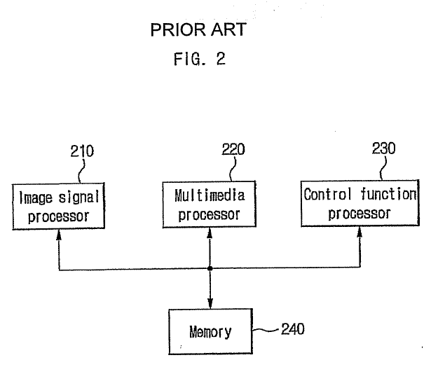

FIG. 3 shows a block diagram of a main processor and an application processor sharing a supplementary memory coupled to the application processor, in accordance with the prior art;

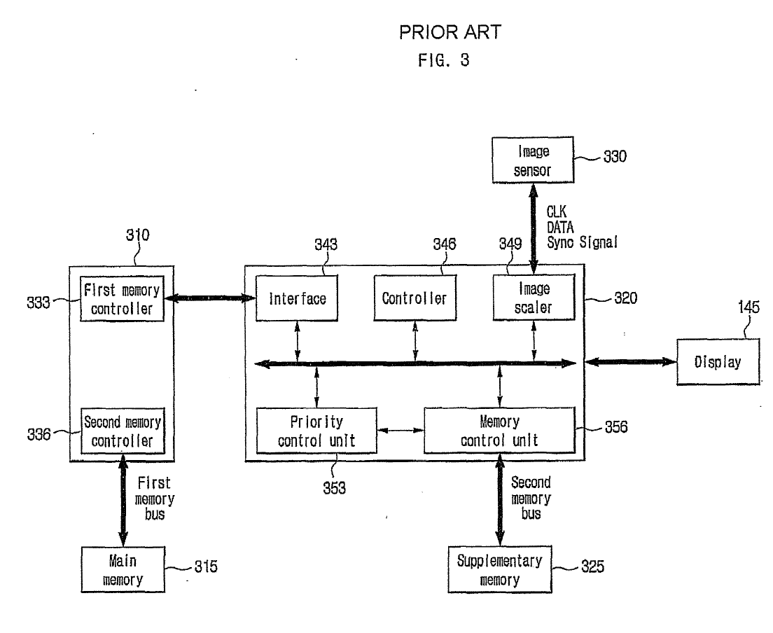

FIG. 4 shows a memory sharing structure in accordance with a preferred embodiment of the present invention;

FIG. 5 shows a flowchart of a method for determining received information by the application processor, in accordance with a preferred embodiment of the present invention; and

FIG. 6 shows a memory sharing structure in accordance with another preferred embodiment of the present invention.

### DESCRIPTION OF KEY ELEMENTS

320: Application processor

343: Interface

346: Controller

349: Image scaler

353: Priority control unit

356: Memory control unit

410: Selection unit

### MODE FOR INVENTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

Although it is evident that the method for sharing a memory in accordance with the present invention can be equivalently applied to all types of digital processing devices or systems (e.g. portable terminals and/or home digital appliances, such as the mobile communication terminal, PDA, portable multimedia player (PMP), MP3 player, digital camera, digital television, audio equipment, etc.), which has a plurality of processors and in which a particular memory needs to be shared by a plurality of processors, the portable terminal will be described hereinafter for the convenience of description and understanding. Moreover, it shall be easily understood through the below description that the present invention is not limited to a specific type of terminal but is applicable equivalently to any terminal having a plurality of processors and a shared memory.

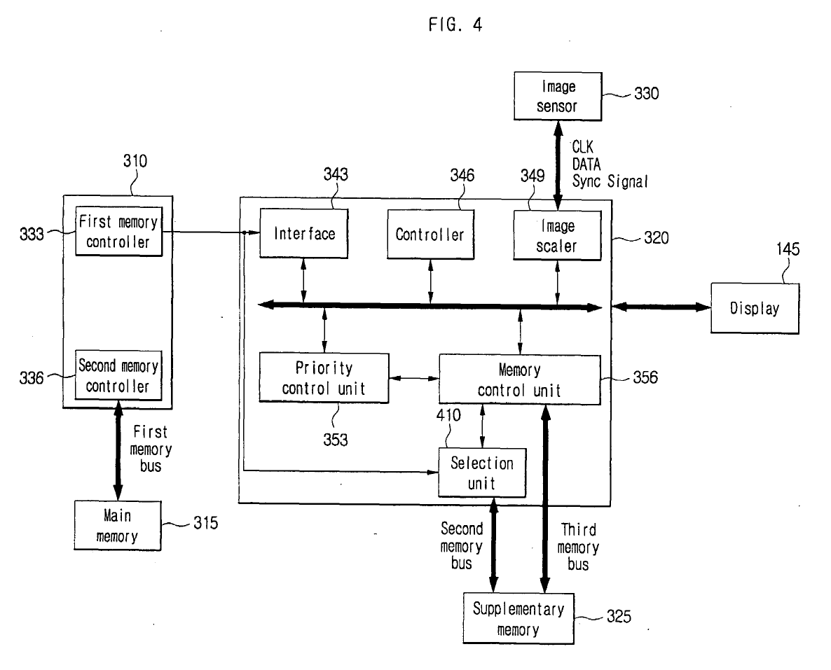

FIG. 4 is a block diagram showing a memory sharing structure in accordance with a preferred embodiment of the present invention. In this description, it is assumed that the application processor is a multimedia processor for controlling the image sensor 330 and for processing multimedia data inputted from the image sensor 330.

Referring to FIG. 4, the main processor 310 comprises a plurality of memory controllers (i.e. the first memory controller 333 and the second memory controller 336). The first memory controller 333 and the second memory controller 336 can be realized as a combined memory controller. The combined memory controller can select the memory to access, using a memory selection signal (i.e. Sel_{—}1 for selecting the supplementary memory 325 and Sel_{—}2 for selecting the main memory 315). The memory processor 310 can also directly control each memory, using the memory selection signal. In case data is to be read from the supplementary memory 325, the main processor 310 can read the data through the second memory bus by directly accessing the selection unit 410 after sending the memory selection signal for selecting the supplementary memory 325 to the interface 343 or the selection unit 410.

In case the main processor 310 sends the memory selection signal (Sel_{—}1) for selecting the supplementary memory to the multimedia processor 320, the multimedia processor 320 sets a route such that the data received from the main processor 310 is stored in the supplementary memory 325 through the second memory bus. In case the memory selection signal is received by the multimedia processor 320, however, the priority control unit 353 can determine the priority of a plurality of data in accordance with a predetermined criterion, as described later. The main processor 310 and the main memory 315 can be embodied in the same chip.

The multimedia processor 320 comprises the interface 343, the controller 346, the image scaler 349, the priority control unit 353, the memory control unit 356 and the selection unit 410. The multimedia processor 320 is coupled to the supplementary memory 325 having two ports through each bus (i.e. a second memory bus and a third memory bus). The multimedia processor 320 and the supplementary memory 325 can be realized in the same chip. In addition, the multimedia processor 320 can be coupled to the display 145 for displaying processed multimedia data.

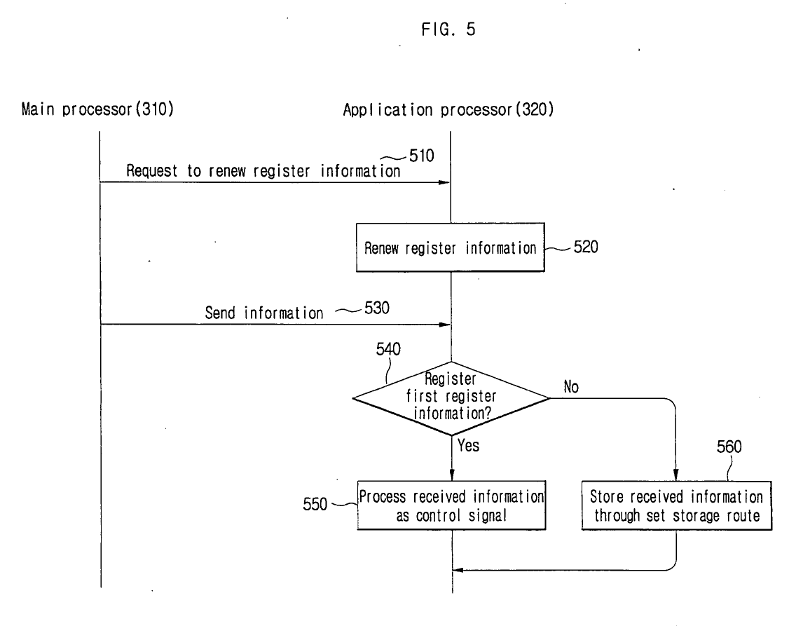

The interface 343 communicates information between the multimedia processor 320 and the main processor 310. The interface 343 is connected to the first memory controller 333 of the main processor 310 (or connected to the combined memory controller, hereinafter, in case the first memory controller and the second memory controller are combined), and interprets the information (e.g. a control signal, data, etc.) received from the main processor 310 to determine whether the information should be stored in the supplementary memory 325 through the second memory bus or used as an internal signal of the multimedia processor 320. As a method for the interface 343 to determine the use (e.g. a control signal, data, etc.) of the information received from the main processor 310, the main processor 310 can pre-write a particular value in a particular register of the multimedia processor 320 or the supplementary memory 325 and deliver the data. For example, if the value written in the particular register is “0”, the information is an internal control signal of the multimedia processor 320, and if the value is “1”, the information is data to be stored in the supplementary memory 325. The method for determining the use of the information received from the main processor 310 will be described later in detail with reference to FIG. 5.

The controller 346 controls internal operations of the multimedia processor 320, using the control signal received from the main processor 310. The controller 346 can be, for example, an MCU (microcontroller unit).

The image scaler 349 changes the size of an image or parameter information by processing the data inputted from the image sensor 330. The data processed by the image scaler 349 is stored in the supplementary memory 325 through the second memory bus by the memory control unit 356.

The priority control unit 353 determines the priority between the image data processed by the image scaler 349 and the data received from the main processor 310. The priority control unit 353 can control to allow the data received from the main processor 310 or the image scaler 349 to always have the priority or to maintain the priority until the main processor 310 or the image scaler 349, occupying the second memory bus, completes the process. In the former case, if the main processor 310 always has the priority while the image scaler 349 is occupying the second memory bus, the priority control unit 353 generates and delivers a priority control signal such that the image scaler 349 releases the occupation of the second memory bus for the storage of the data received from the main processor 310.

The memory control unit 356 controls the data communication through the memory bus connected to each of the two ports of the supplementary memory 325. The memory control unit 356 controls the data received from the main processor 310 or from the image scaler 349 to be written in the supplementary memory 325 through the second memory bus, and controls the multimedia processor 320 to write data in or read data from the supplementary memory 325 through a third memory bus. The memory control unit 356 can control such that the data (i.e. either of the data received from the main processor 310 or the data received from the image scaler 349) corresponding to the priority control signal received from the priority control unit 353 is only delivered to the selection unit 410.

The selection unit 410 controls to allow only the data (i.e. either the data received from the main processor 310 or the data received from the image scaler 349) corresponding to the priority control signal, either directly received from the priority control unit 353 or received through the memory control unit 356, is written in the supplementary memory 325 through the second memory bus. The priority control unit 353 and the selection unit 410 can be combined in one element. The selection unit 410 can be directly connected to the main processor 310, which attempts to read the data stored in the supplementary memory 325, and in case the second memory bus is not occupied by the image scaler 349, the selection unit 410 sets the route such that the main processor 310 can read the pertinent data from the supplementary memory 325 through the second memory bus. In case the reading by the main processor 310 has the priority over the storing by the image scaler 349, the selection unit 410 can set the route such that the image scaler stops the storing operation and the main processor 310 carries out the reading operation. That is, the data received from the main processor 310 will be routed to the selection unit 410 through the interface 343 and the memory control unit 356. In case the data stored in the supplementary memory 325 is read by the main processor 310, the data can be provide in the reverse order, but the data can be read by using the memory selection signal to directly access the selection unit 410.

The supplementary memory 315 has two independent access ports. The first port is connected to the selection unit 410 through the second memory bus to write the data received from the main processor 310, read the data stored in the main processor 310 or to write the data received from the image scaler 349. The time in which the image scaler 349 writes the data through the second memory bus can be restricted to the time in which the main processor 310 does not occupy the second memory bus. The second ports is connected to the memory control unit 356 through the third memory bus and is used for having a particular element of the multimedia processor 320 to access data needed for data processing (e.g. processing multimedia data such as MPEG4, JPEG and Audio). In case the request for writing data on the same address is received through each port at the same time, the supplementary memory 325 can treat the request as an error or assign the priority.

Hereinafter, the additional characteristics of the memory sharing structure in accordance with the present invention will be described.

First of all, since the main processor 310 can communicate with the multimedia processor 320 by use of bus interface signals of the memory controller 310, it is possible to carry out data communication and control operation with one bus only. Moreover, using the pertinent bus, it is possible to directly communicate with the supplementary memory 325, enabling prompt transmission of data.

Next, since the data inputted from the image sensor 330 can be stored real time in the supplementary memory 325 while the main processor 310 is not occupying the second memory bus, the multimedia processor 320 can diversify the use of the supplementary memory 325 according to the operation mode (e.g. performing the camera function or playing back audio data) of the multimedia processor 320. In other words, since the multimedia processor receives different data and control signal from the main processor 310, depending on the operation mode, the operation mode that does not need to receive separate data or control signal from the main processor 310 stores the data from the image sensor 330 real time, increasing the storing speed of the image data, thereby maximizing the efficiency of memory use. Of course, as described earlier, in the operation mode that does not need to receive separate data from the main processor 310, there can be a variety of processes depending on the priority of the data from the image sensor 320.

Next, the supplementary memory 325 can have two ports, and separate the port for writing image data from the port for processing image data, thereby maximizing the process efficiency of multimedia data and minimizing the loss of image data. This is because data gets lost if any data is not stored in the supplementary memory 325, since the data is inputted from the image sensor 330 real time. In the case of the prior art, which uses one port, image data is consecutively stored in order to prevent the data loss, delaying the time in using the supplementary memory 325 in the multimedia processor 320 or a particular element.

FIG. 5 is a flowchart showing the method for determining received information by the application processor, in accordance with a preferred embodiment of the present invention.

As described above, the application processor 320 (e.g. a multimedia processor) in accordance with the present invention is connected to the supplementary memory 325 having two ports. One port is used by the application processor 320 itself, eliminating the bottleneck while processing the internal signal. The other port provides a route such that the main processor 310 or a connected input device (e.g. an image sensor 330 in case of a multimedia processor) can access the supplementary memory 325. In other words, the main processor 310 uses the memory selection signal to directly access the supplementary memory 325 and read the necessary data, or allows the selection unit 410 to use a bus for writing data in the supplementary memory 325 according to the priority of data received from the main processor 310 or inputted data processing device (e.g. an image scaler 349 in case of a multimedia processor).

As such, a variety of information (e.g. a control signal, data writing request and data reading request) is communicated between the main processor 310 and the application processor 320, and the application processor 320 need to interpret the information received from the main processor 310 to determine its purpose. Hereinafter, the method by the application processor 320 for determining and processing the information received from the main processor 310 will be described with reference to FIG. 5.

Referring to FIG. 5, in step 510, the main processor 310 requests the application processor 320 to renew the register information. For example, if the value registered in the pertinent register is a first register value (e.g. “0”), the information that is delivered later can be an internal control signal of the application processor 320, and if the registered value is a second register value (e.g. “2”), the information to be delivered later can be data to be stored in the supplementary memory 325.

The application processor 320 renews the register information to correspond to the register information renew request received from the main processor 320, in step 520. The register information can be a register in the application processor 320.

The above steps 510-520 can be needed only if information that is different from the information that has been sent by the main processor 310 is delivered, and if the information has the same purpose as the information that has been sent, these steps can be skipped.

In step 530, the main processor 310 sends information to the application processor 320.

In step 540, the application processor 320 determines whether the register information that has been renewed in step 520 is the first register value.

If the value registered in the pertinent register is the first register value, the application processor recognizes that the information received in step 530 is a control signal for controlling the application processor 320, and performs a process operation (e.g. processing and playing back multimedia data) corresponding to the received control signal, in step 550. The execution of the process operation corresponding to the control signal can be controlled by the controller 346.

However, if the value registered in the pertinent register is the second register value, the application processor recognizes that the information received in step 530 is data to be stored in the supplementary memory 325, and performs a storing operation in step 560. Here, the priority control unit 353 generates a priority control signal that makes the data received from the main processor 310 stored in the supplementary memory 325 and sends the priority control signal to the memory control unit 356 and/or the selection unit 410. The selection unit 410 makes the data received from the main processor 310 stored through the second memory bus (refer to FIG. 4).

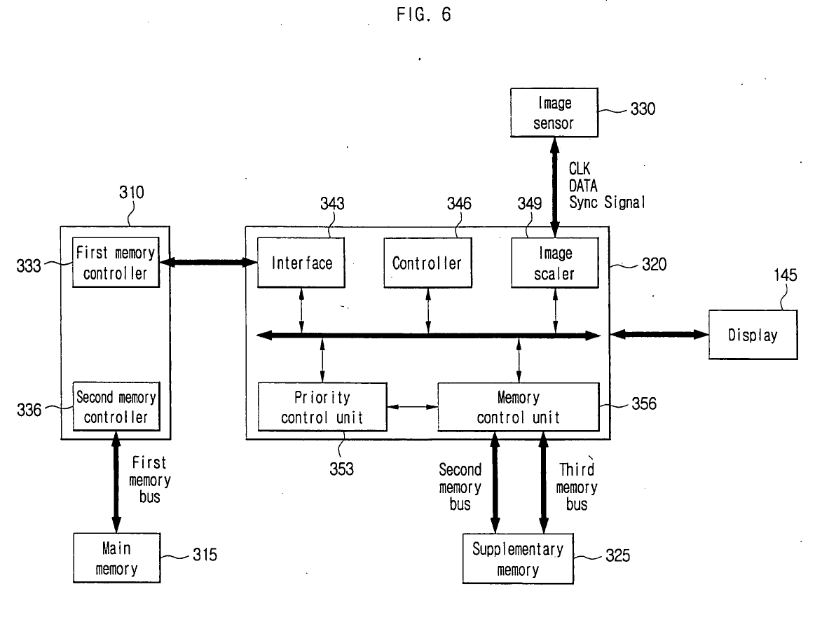

FIG. 6 is a diagram showing the memory sharing structure in accordance with another preferred embodiment of the present invention. It is assumed that the application processor controls the image sensor 330 and is a multimedia processor for processing multimedia data inputted from the image sensor 330.

Unlike FIG. 4, FIG. 6 shows that the selection unit 410 is combined in the memory control unit 356. That is, the memory control unit 356 controls the data communication through the memory buses, each of which is connected to each of the two ports comprised in the supplementary memory 325. The memory control unit 356 controls the data corresponding to the priority control signal received from the priority control unit 353, between the data received from the main processor 310 and the data received from the image scaler 349, to be written in the supplementary memory 325 through the second memory bus.

In case the main processor 310 attempts to read the data stored in the supplementary memory 325, the main processor 310 can be routed through the interface 343 to access the memory control unit 356, or directly access the memory control unit 356, which is similar to the case of FIG. 4.

Other cases can be easily understood by those of ordinary skill in the art through the above description, and thus will not be provided here.

The drawings and detailed description are only examples of the present invention, serve only for describing the present invention, and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, the present invention can minimize the loss of process efficiency of the application processor and minimize the delay of time when processing a high-performance, high-resolution image.

The present invention can also allow the main processor to control the application processor and communicate data with the application processor through a single bus.

In addition, the present invention can optimize the memory efficiency by allowing image data inputted from the image sensor to be stored in the supplementary memory regardless of the operation status of the multimedia processor.

Moreover, the present invention can control the loss of data by eliminating the delay in time when storing the image data inputted from the image sensor and maximize the process efficiency of the application processor by applying different ports for storing the image data and for processing the image data.

What is claimed is

1. A digital processing apparatus comprising:
a main processor;
an application processor operatively coupled to the main processor through one connection bus; and
a memory, the memory having a plurality of ports, the plurality of ports being coupled to the application processor through a plurality of memory buses, each of the plurality of ports being coupled to the application processor through a separate memory bus.

2. The digital processing apparatus of claim 1, at least one of the plurality of memory buses is exclusively occupied by the application processor for the purpose of reading data stored in the memory or storing processed data in the memory.

3. The digital processing apparatus of claim 1, wherein the application processor comprises an interface, the interface receiving information corresponding to one from a group consisting of a control signal and data from the main processor through the connection bus,
whereas the data is stored in the memory through a memory bus, among the plurality of memory buses, assigned to store data received from the main processor.

4. The digital processing apparatus of claim 1, wherein the application processor comprises a processing unit, the processing unit processing input data inputted from a coupled input device,
whereas the processed input data is stored in the memory through a memory bus, among the plurality of memory buses, assigned to store processed input data.

5. The digital processing apparatus of claim 4, wherein the input device is an image sensor.

6. The digital processing apparatus of claim 1, wherein the application processor comprises:
an interface, receiving information corresponding to one from a group consisting of a control signal and data from the main processor through the connection bus;
a processing unit, processing input data inputted from a coupled input device;
a priority control unit, generating a priority control signal for data received from the main processor and the processed input data; and
a route setting unit, storing the data received from the main processor or the processed input data in the memory through one memory bus, assigned among the plurality of memory buses, to correspond to the priority control signal.

7. The digital processing apparatus of claim 3, wherein the application processor has a register for recognizing the purpose of the information; the value registered in the register is controlled by the main processor; and the interface determines, upon receiving information from the main processor, whether the information is the control signal or the data, based on the value registered in the register,.

8. The digital processing apparatus of claim 1, wherein the main processor reads registered data by accessing the memory through one assigned memory bus among the plurality of memory buses.

9. The digital processing apparatus of claim 1, wherein the application processor and the memory are embodied in the same chip.

10. A method for sharing a memory coupled to an application processor with a main processor, the method comprising:
(a) receiving a request for writing data from the main processor; and
(b) writing data in the memory through a first bus, the data corresponding to the received request for writing data,
wherein the application processor controlled by the main processor is connected to the main processor through one connection bus; the memory has a plurality of ports; the plurality of ports are coupled to the application processor through a plurality of memory buses; and each port of the plurality of ports is coupled to the application processor through a separate memory bus.

11. The method of claim 10, wherein a second bus, among the plurality of memory buses, is exclusively occupied by the application processor for the purpose of reading data stored in the memory or storing processed data in the memory.

12. The method of claim 10, wherein, in case input data is further received from an input device, to which the application processor is coupled, the step (b) comprises:
determining the priority of data received from the main processor and the input data, based on a predetermined rule of determining the priority; and
in case the data received from the main processor has the priority, writing data corresponding to the request received through the first bus for writing data in the memory through the first bus.

13. The method of claim 12, wherein the input device is an image sensor.
